(19) United States
(12) Patent Application Publication
(10) Pub. No.: US 2010/0010930 A1
(43) Pub. Date: Jan. 14, 2010

(54) PROVIDING A REAL TIME CREDIT SCORE AS PART OF A TRANSACTION REQUEST

(75) Inventors: Clinton R. Allen, Chandler, AZ (US); Glade R. Erikson, Glendale, AZ (US); Dwayne Fisher, Kendall Park, NJ (US); Sanjiv Khosla, Brooklyn, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/172,115

(22) Filed: Jul. 11, 2008

(51) Int. Cl. G06Q 40/00

(52) U.S. Cl. 705/38; 705/35

(57) ABSTRACT

Providing a real time credit score to a transaction account issuer as part of the transaction authorization request message is disclosed. A payment processor augments the transaction request received from a customer or merchant by calculating a credit score and adding it to the authorization request message. The real time credit score calculation may be based upon data stored by the payment processor and upon information collected from credit bureaus, transaction account issuers and other third-party sources.

### FIELD OF THE INVENTION

The present invention generally relates to enabling payment processors to provide enhanced service to transaction account issuers, and more particularly, to calculating and providing a real time credit score as part of a transaction authorization request.

### BACKGROUND OF THE INVENTION

Many transaction accounts provide the ability for account users to perform financial transactions (i.e. buy goods or services) on credit. Managing transaction account holder credit risk is one of the largest challenges confronted by transaction account issuers. Transaction account issuers, such as credit card issuing institutions, bear the risk that the account holder may default on the credit extended to them. In order to manage the credit risk of transaction account holders, transaction account issuers often employ various methods to assess the credit risk of the account holder. The account issuer often performs such credit risk assessments periodically, assessing the account holder's credit risk based upon a pre-determined schedule or event, and limiting the credit extended to account holders in light of the periodic assessments.

Though issuers may traditionally manage credit risk by setting credit lines and by periodic risk assessment, this procedure is limited because it does not account for activity that has occurred since the last risk assessment that may have impacted the probability that an account holder will default on credit payments. This limited ability to assess account holder risk often results in either an overly conservative approach, wherein account issuers needlessly limit credit and/or product offerings, or an overly risky approach wherein issuers rely on the traditional periodic credit risk assessments that fail to avoid or mitigate an unacceptable default risk.

Accordingly, there is a strong, long-felt need for a method and a system for enhancing the credit risk assessment process by calculating a real time credit score each time a transaction request is received.

### SUMMARY OF THE INVENTION

The present invention improves upon existing systems and methods by providing a tangible, integrated, customized and real time credit score in association with the receipt of a transaction request. When a merchant requests authorization of a transaction via a payment processor (e.g. a credit card network) from a transaction account issuer (e.g. a bank), the payment processor augments the request with information that enables the account issuer to better assess the default risk associated with the transaction. For instance, in one embodiment, the payment processor uses credit bureau information, transaction history information, transaction information and account information (e.g., payment history) to calculate the real time credit score which reflects the probability that the customer will default on the transaction account.

In one embodiment, the payment processor system receives a transaction authorization request from a merchant and enhances the ability of the account issuer to make an authorization decision. The system calculates a real time credit score and includes it in the authorization request it sends to the account issuer. The system receives the authorization reply message from the account issuer and transmits it to the merchant.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for providing a real time credit score, in accordance with one embodiment of the present invention.

FIG. 2 is a representative process flow diagram for using a real time credit score to enhance the ability of an account issuer to assess the default risk of a customer, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a software module, logic engines, computer hardware, numerous databases and computer networks. While the system may contemplate upgrades or reconfigurations of existing processing systems, changes to existing databases and business information system tools are not necessarily required by the present invention.

The exemplary benefits provided by this invention to transaction account issuers include increased data accuracy, mitigated credit risk, increased processing efficiency, increased operational efficiency and increased confidence to develop products and extend credit to credit-worthy customers. Payment processors also benefit by increasing the value of the service that they provide to transaction account issuers.

While described in the context of systems and methods for enhancing the data submitted to a transaction account issuer during a transaction authorization request, practitioners will appreciate that the present invention may be similarly used to enhance functionality, mitigate credit risk, decrease overall cost, and enhance the credit decision process in the context of providing real time credit risk assessment to any entity and/or for any process that may benefit from an enhanced, up-to-the minute credit risk assessment data. Moreover, other embodiments of such real time credit risk assessment techniques may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of transaction authorization requests may be accomplished by using a variety of user interfaces including personal computers, point of service (“POS”) devices, kiosks, handheld devices such as personal digital assistants and cellular telephones.

“Entity” may include any individual, consumer, customer, group, business, organization, government entity, transaction account issuer or processor (e.g., credit, charge, etc), merchant, consortium of merchants, account holder, charitable organization, software, hardware, and/or any other entity or someone acting on behalf of the entity or user.

An “account”, “account number” or “customer account” as used herein, may include any device, code (e.g., one or more of an authorization/access code, personal identification number (“PIN”), user profile, demographic, Internet code, other identification code, and/or the like), number, letter, symbol, digital certificate, smart chip, digital signal, analog signal, biometric or other identifier/indicia suitably configured to allow the consumer to access, interact with, be identified by or communicate with the system. The account number may optionally be located on or associated with a rewards card, charge card, credit card, debit card, prepaid card, telephone card, secure hardware area or software element associated with a phone or mobile device, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, the system may include any device having a transponder which is configured to communicate with an RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

A “transaction account” (“TXA”) includes any account that may be used to facilitate a transaction, e.g. financial, loyalty points, rewards program, access, exchange, etc.

A “TXA issuer” may include any entity which issues accounts, processes transactions (e.g., payment processor), acquires financial information, settles accounts, conducts dispute resolution regarding accounts, and/or the like.

A “customer” includes any entity that has a TXA with a TXA issuer (e.g., user or merchant).

A “merchant” includes any entity that receives payment or other consideration. For example, a merchant may request payment for services rendered from a customer who holds an account with a TXA issuer.

A “payment processor” may include any entity which processes transactions, issues accounts (e.g., TXA issuer), acquires financial information, settles accounts, conducts dispute resolution regarding accounts, and/or the like. For example, a payment processor may provide data transfer capabilities that transfer data from a customer or merchant at a point-of-sale (POS) terminal to the TXA issuer and then back to the POS terminal.

“TXA identification data” (“TXA-ID”) includes data used to identify, coordinate, verify or authorize a customer. The TXA-ID may also provide unique identification, validation and/or unique authorization. The TXA-ID may include, for example, a code, authorization code, validation code, access code, a transaction account identification number, demographic data, encryption key, proxy account number, PIN, Internet code, card identification number (CID), number, letter, symbol, digital certificate, smart chip, digital signal, analog signal, RFID, biometric or other identifier/indicia suitably configured to uniquely identify a customer and associated TXA and/or to authorize a transaction to a TXA. A CID number is used in many credit or charge card transaction accounts. For further information regarding CIDs see, for example: Systems and Methods for Authorizing a Transaction Card, U.S. Pat. No. 6,182,894 issued on Feb. 5, 2001; and System and Method for Facilitating a Financial Transaction with a Dynamically Generated Identifier, U.S. Ser. No. 11/847,088 filed on Aug. 29, 2007, both of which are hereby incorporated by reference.

A “real time” credit score may include the calculation of a credit score, insertion of the credit score in the authorization request and/or acquiring data (e.g., internal acquisition, or from another database) used to calculate the credit score in a certain time period. “Real time” may include performing any or all of such actions within seconds or minutes of receiving a request, prior to receiving the request, or within any other period of time. The “real time” process may also include batch processing of the requests, synchronous processing and/or asynchronous processing.

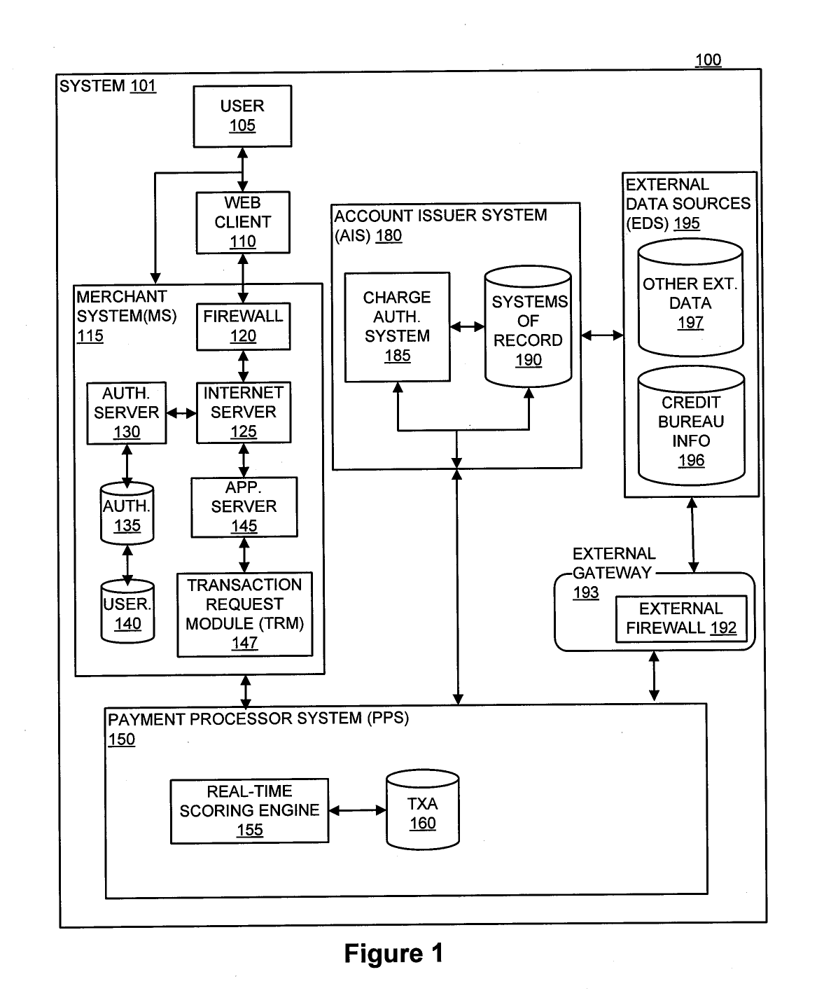

With reference to FIG. 1, in one embodiment, system 101 includes a user 105 interfacing with a merchant system (“MS”) 115 by way of a web client 110. User 105 may include any individual or entity that interacts with and/or acts within system 101. User 105 may perform tasks such as requesting, retrieving, receiving, updating, analyzing, entering and/or modifying data. User 105 may be, for example, a customer accessing a merchant through a web client 110 to conduct e-commerce and requesting authorization to charge a TXA. User 105 may interface with Internet server 125 via any communication protocol, device or method discussed herein, known in the art, or later developed. In one embodiment, user 105 may interact with MS 115 via an Internet browser at a web client 110. In one embodiment, user 105 may be, for example, a customer or a merchant that interacts with MS 115 via a web client 110 that is a point of sale device. In one embodiment, user 105 may interact with MS 115 via proprietary networks, legacy networks, telecommunication networks or other networks and/or communication links that take advantage of protocols other than the typical Internet protocols.

Web client 110 comprises any hardware and/or software suitably configured to facilitate requesting, retrieving, updating, analyzing, entering and/or modifying data. The data may include verification data, authentication data, authorization data, e-commerce related data or any information discussed herein. Web client 110 includes any device (e.g., personal computer, mobile device), which communicates (in any manner discussed herein) with MS 115 via any network discussed herein. Such browser applications comprise Internet browsing software installed within a computing unit or system to conduct online transactions and communications. These computing units or systems may take the form of a computer or set of computers, although other types of computing units or systems may be used, including: laptops, notebooks, hand held computers, mobile phones, mobile devices, POS devices, kiosks, card authorization devices, RFID reader, set-top boxes, workstations, computer-servers, main frame computers, mini-computers, PC servers, pervasive computers, network sets of computers, and/or the like. Practitioners will appreciate that web client 110 may or may not be in direct contact with MS 115. For example, web client 110 may access the services of MS 115 through another server, which may have a direct or indirect connection to Internet server 125.

The invention contemplates uses in association with e-commerce systems, authorization systems, TXA services, payment processor networks, customer service systems, customer portals, reporting systems, web services, pervasive and individualized solutions, open source, biometrics, mobility and wireless solutions, commodity computing, grid computing and/or mesh computing. For example, in an embodiment, web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

User 105 may communicate with MS 115 through firewall 120 to help ensure the integrity of MS 115 components. Internet server 125 may include any hardware and/or software suitably configured to facilitate communications between web client 110 and one or more MS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140.

Authentication database 135 may store information used in the authentication process such as, for example, user identifiers, passwords, access privileges, user preferences, user statistics, and the like. User database 140 maintains user information and credentials for MS 115 users.

Application server 145 may include any hardware and/or software suitably configured to serve applications and data to a connected web client 110. Transaction request module “TRM” 147 is configured to process authorization requests and responses. TRM 147 functions include, for example, validating TXA information, prompting user 105 with security challenges, verifying user 105 responses, authenticating the user, requesting authorization, processing authorization responses, initiating other business modules, encrypting and decrypting. Additionally, TRM 147 may include any hardware and/or software suitably configured to receive requests from the web client 110 via Internet server 125 and application server 145. TRM 147 is further configured to process requests, receive responses, execute transactions, construct database queries, and/or execute queries against databases within system 101, external data sources and temporary databases, as well as exchange data with other application modules (not pictured). Moreover, TRM 147 may reside as a standalone system or may be incorporated with application server 145 or any other MS 115 component as program code.

Payment processing system (“PPS”) 150 provides services that enable transactions such as data transfer, message or request transfer, data augmentation and data retrieval from remote or third-party systems. PPS 150 communicates with MS 115 and account issuer system (“AIS”) 180 to enable financial transactions. PPS 150 communicates with other system 101 components such as external data sources (“EDS”) 195.

Real time scoring engine (“RTSE”) 155 includes a software module configured to provide a credit risk assessment on demand and in real time. For example, when a transaction request is received by PPS 150, RTSE 155 may access stored data, external data and derived or calculated data to generate a credit risk assessment or score associated with the transaction or the TXA holder.

TXA database 160 stores information regarding current transaction requests and previous transactions. For example, TXA database 160 includes account information, merchant information, amounts, dates and times for financial transaction requests.

AIS 180 includes the TXA issuer systems. AIS 180 receives transaction authorization requests from PPS 150 and returns authorization messages to PPS 150. AIS 180 communicates with other system 101 components such as EDS 195. AIS 180 may communicate with PPS 150, or RTSE 155 directly, to provide input data to the credit risk assessment process.

Charge authorization system (“CAS”) 185 coordinates, authorizes and/or executes charges to TXAs. In one embodiment, CAS 185 provides data to the credit scoring process by, for example, providing information on recently authorized transactions, etc.

Database systems of record (“SOR”) 190 includes the databases of record for the TXA issuer. SOR 190 may provide, for example, TXA account data, transaction history data, product information, legal and regulatory data, and the like.

External data sources (“EDS”) 195 include other sources of data that may be useful in assessing the credit-worthiness of a TXA holder such as, for example, data provided by other TXA issuers or other lending institutions.

Credit bureau information 196 includes data provided by third party credit bureaus (e.g. TRW, Equifax, etc.).

FIG. 1 depicts databases that are included in an exemplary embodiment of the invention. A representative list of various databases used herein includes: user authentication database 135, user database 140, SOR 190, TXA database 160, credit bureau data 196, other external data 197 and/or other databases that aid in the functioning of the system. As practitioners will appreciate, while depicted as a single entity for the purposes of illustration, databases residing within system 101 may represent multiple hardware, software, database, data structure and networking components. As practitioners will appreciate, embodiments are not limited to the exemplary databases described above, nor do embodiments necessarily utilize each of the disclosed exemplary databases.

In addition to the components described above, system 101, MS 115, PPS 150, AIS 180 and EDS 195 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Web client 110 may include an operating system (e.g., Windows Mobile OS, Windows CE, Palm OS, Symbian OS, Blackberry OS, J2ME, Window XP, Windows NT, 95/98/2000, XP, Vista, OS2, UNIX, Linux, Solaris, MacOS, etc.) as well as various conventional support software and drivers typically associated with mobile devices, computers or other user interfaces. Web client 110 can be in a home or business environment with access to a network including both wireless and wired network connections. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp. Web client 110 may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996), which is hereby incorporated by reference.

Firewall 120 may comprise any hardware and/or software suitably configured to protect the MS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Similar to Internet server 125, the application server 145 may communicate with any number of other servers, databases and/or components through any means known in the art. Further, the application server 145 may serve as a conduit between the web client 110 and the various systems and components of the MS 115. Internet server 125 may interface with the application server 145 through any means known in the art including a LAN/WAN, for example. Application server 145 may further invoke software modules such as the TRM 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 101, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier, TXA-ID or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 101 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

System 101 may be interconnected to external data sources, EDS 195, (for example, to obtain data from a vendor) via a second network, referred to as the external gateway 193.

The external gateway 193 may include any hardware and/or software suitably configured to facilitate communications and/or process transactions between systems. Although depicted in FIG. 1 as facilitation communication between EDS 195 and PPS 150, one skilled in the art will appreciate that external gateway 193 may be suitably configured to facilitate communications and/or process transactions between any two systems or sub-systems including system 101, PPS 150, MS 115 and the EDS 195. Interconnection gateways are commercially available and known in the art. External gateway 193 may be implemented through commercially available hardware and/or software, through custom hardware and/or software components, or through a combination thereof. External gateway 193 may reside in a variety of configurations and may exist as a standalone system or may be a software component residing, for example, inside PPS 150, EDS 195 or any other known configuration. External gateway 193 may be configured to deliver data directly to system 101 components (such as RTSE 155) and to interact with other systems and components such as EDS 195 databases. In one embodiment, external gateway 193 may comprise web services that are invoked to exchange data between the various disclosed systems. External gateway 193 represents existing proprietary networks that presently accommodate data exchange for data such as financial transactions, customer demographics, billing transactions and the like. External gateway 193 is a closed network that is assumed to be secure from eavesdroppers.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

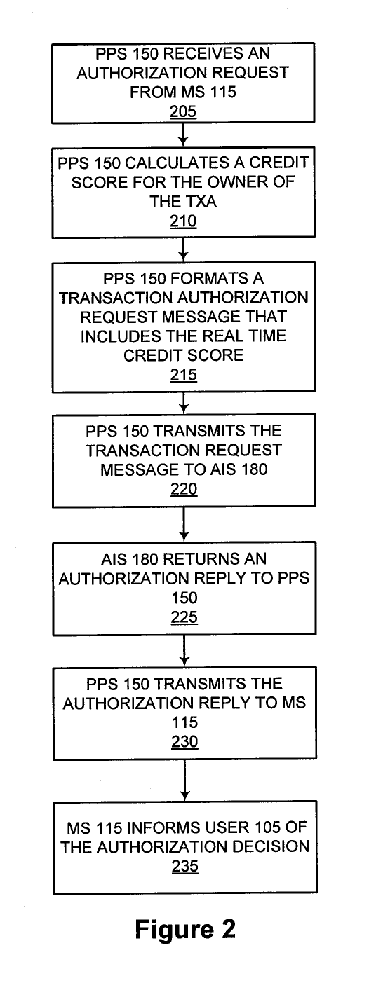

The block system diagrams and process flow diagrams represent mere embodiments of the invention and are not intended to limit the scope of the invention as described herein. For example, the steps recited in FIG. 2 may be executed in any order and are not limited to the order presented. It will be appreciated that the following description makes appropriate references not only to the steps depicted in FIG. 2, but also to the various system components as described above with reference to FIG. 1.

With reference to FIG. 1, in one embodiment, when user 105 logs on to an application, Internet server 125 may invoke an application server 145. Application server 145 invokes logic in TRM 147 by passing parameters relating to user's 105 requests for data. MS 115 manages requests for data from TRM 147 and communicates with system 101 components such as, for example, PPS 150. Transmissions between user 105 and Internet server 125 may pass through a firewall 120 to help ensure the integrity of MS 115 components. Practitioners will appreciate that the invention may incorporate any number of security schemes or none at all. In one embodiment, Internet server 125 receives data or page requests from web client 110 and interacts with various other system 101 components to perform tasks related to requests from web client 110.

Internet server 125 may invoke an authentication server 130 to verify the identity of user 105 and assign specific access rights to user 105. In order to control access to application server 145 or any other component of MS 115, Internet server 125 may invoke authentication server 130 in response to user 105 submissions of authentication credentials received at Internet server 125. When a request to access system 101 is received from Internet server 125, Internet server 125 determines if authentication is required and transmits a prompt to web client 110. User 105 enters authentication data at web client 110, which transmits the authentication data to Internet server 125. Internet server 125 passes the authentication data to authentication server which queries user database 140 for corresponding credentials. When user 105 is authenticated, user 105 may access various applications and their corresponding data sources.

Referring now to FIG. 2, a representative process for providing a real time credit score to enhance the ability of a TXA issuer to assess the default risk of a customer is shown. User 105 is a customer requesting a transaction using a TXA. In a typical situation, user 105 accesses the online store of a merchant and wishes to purchase items from the store using a transaction account. User 105 specifies the account code and TXA-ID (e.g. a credit card number and CID) and submits it with a purchase request.

In other embodiments, a POS terminal acquires the user information and account information while the user is in a merchant establishment, when a user calls the merchant on the phone or when a user otherwise communicates the information to a merchant. At the time of purchase the transaction request data may be communicated to a POS device by for, example, swiping a card or waving a fob near a radio frequency (RF) reader.

MS 115 sends a TXA charge authorization request to the payment processor system, PPS 150. PPS 150 receives an authorization request from MS 115 (step 205). PPS 150 calculates a real-time or near real time credit score (step 210). The real time credit score is calculated using any probabilistic, modeling, forecasting, financial, mathematical or prediction technique known in the art. The credit score calculated by PPS 150 at the time of a transaction request provides enhanced value and accuracy to the TXA issuer because it reflects a more accurate assessment of the default risk associated with the transaction account. Calculating the credit score in real time may include analyzing a variety of information from multitude of sources. For instance, PPS 150 analyzes information about the requested transaction and/or information stored in its own databases (e.g. TXA database 160) and data obtained from the TXA issuer, a credit bureau (e.g. the credit score assigned by a credit bureau) or from a third-party. In one embodiment, PPS 150 accesses data on TXA database 160 to assess recent transaction history associated with a TXA and/or a user. Credit risk may be assessed using transaction amounts, frequency, merchant type, etc. A credit score is calculated using up to date information reflecting a customer's creditworthiness and probability of default (Step 210).

In one embodiment, AIS 180 (i.e. the TXA issuer systems) obtains credit scores from credit bureaus or other customer or credit data maintained by third-parties and uses other information stored in SOR 190 to calculate a TXA issuer credit score for a customer. PPS 150 obtains the TXA issuer credit score from AIS 180 and RTSE 155 uses that data, along with data stored within TXA database 160 and/or data acquired in real time from other external data sources 197, to calculate a real time credit score.

In one embodiment, PPS 150 accesses credit bureau information directly and RTSE 155 calculates a credit score by performing a forecast that considers factors such as, for example, transaction amount, recent transaction activity or frequency, accounts receivable data, payment history, customer profile information, demographic data, economic trends etc. These factors are assessed based upon data that may be provided by the TXA issuer (via AIS 180) or by a third party. For example, in one embodiment, the AIS 180 provides payment history, customer profile information and accounts receivable data to while PPS 150 receives other information regarding the customer's spending and payment habits, economic trends and demographic data from other external data sources 197. In one embodiment, RTSE 155 uses information related to the current transaction (i.e. the transaction that is requested for approval) such as the transaction amount, transaction location, transaction method (e.g. online, phone or in store) and merchant type to calculate the real time credit score.

In one embodiment, user 105 submits TXA identifiers for multiple TXAs in a request to charge one TXA and RTSE 155 uses information regarding multiple TXAs as part of the real-time credit score calculation. In one embodiment, the TXA history of one or more TXAs includes information regarding transaction amounts, TXA balance, transaction frequency, transaction locations, transaction dates and times, type of merchant, type of product, transaction approvals and denials and the like. Such TXA history provides up to date data for use in risk assessment and prediction methods.

PPS 150 creates a transaction authorization request message that includes the real time credit score (Step 215). In one embodiment, PPS 150 creates the authorization request by storing the credit score in an existing data field, i.e. a data field that is part of the traditional transaction account message format. In one embodiment, the real-time credit score is transmitted in a new data field or in a separate message that is associated with the transaction request message.

PPS 150 transmits the transaction authorization request to AIS 180 (Step 220). In one embodiment, AIS 180 may request additional data from PPS 150 such as, for example, the data that was used to calculate the real-time credit score, to enable the TXA issuer to make an even more informed credit decision. AIS 180 returns an authorization reply to PPS 150 (Step 225). The authorization reply may include an approval, a denial, a partial approval, a contingent approval or a request for additional data. PPS 150 transmits the authorization reply to MS 115 (Step 230) and MS 115 informs user 105 of the authorization decision (Step 235).

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method for communicating a real-time credit score, the method comprising:
receiving an authorization request from a merchant system;
calculating a credit score;
transmitting the credit score to an issuer in an authorization request message;
receiving an authorization reply; and,
transmitting the authorization reply to the merchant system.

2. The method of claim 1, wherein calculating a credit score comprises analyzing information from at least one of: the issuer, a third party, a credit bureau, transaction history, and current transaction.

3. The method of claim 1, further comprising receiving at least one of credit bureau information, default risk, payment data, accounts receivable data and profile information from the issuer.

4. The method of claim 1, wherein calculating the credit score comprises using the issuer determined default risk and information from at least one of the issuer, a third party, a credit bureau, transaction history, and current transaction.

5. The method of claim 1, wherein calculating the credit score comprises calculating an issuer risk assessment.

6. The method of claim 1, wherein calculating the credit score comprises receiving a credit score from a credit bureau.

7. The method of claim 1, wherein calculating the credit score comprises analyzing transaction history which comprises at least one of: transaction frequency, transaction amounts, cumulative transaction amounts, total number of transactions, type of merchant, location of merchant, credit line, credit line open to buy, fraud history, transaction approvals, and transaction denials.

8. The method of claim 1, wherein calculating the credit score comprises analyzing a current transaction which comprises at least one of: transaction amount, cumulative transaction amount, total number of transactions, type of merchant, type of product, location of merchant, transaction date, transaction time, transaction approvals, and transaction denials.

9. The method of claim 1, wherein the authorization reply comprises at least one of: approval, denial, partial approval, and a request to contact at least one of the issuer and a third party.

10. The method of claim 1, wherein receiving the authorization reply comprises receiving the authorization reply from the issuer, wherein the issuer takes additional steps to manage credit risk.

11. The method of claim 1, wherein the authorization request comprises multiple transaction account identifiers associated with multiple transaction accounts, and wherein the credit score is based on analyzing information from the multiple transaction accounts.

12. The method of claim 1, wherein the authorization request comprises multiple transaction account identifiers associated with multiple transaction accounts issued by different issuing banks, and wherein the credit score is based on analyzing information from the multiple transaction accounts.

13. A method for receiving an authorization request message, the method comprising:
receiving a credit score in the authorization request message, wherein the authorization request message is obtained from a merchant system, and wherein the credit score is calculated by a payment processor and the credit score and authorization request is inserted into the authorization request message by the payment processor; and,
transmitting an authorization reply.

14. The method of claim 13, further comprising managing a credit risk for an account associated with the authorization request message.

15. The method of claim 13, further comprising:
receiving a request for data associated with an account, wherein the account is associated with the authorization request message; and,
transmitting data associated with the account, wherein the data is used to calculate the credit score.

16. The method of claim 13, further comprising providing credit risk assessment data to the payment processor.

17. A method for obtaining an authorization decision based on a real-time credit score, the method comprising:
transmitting an authorization request message to a payment processor, wherein the payment processor calculates the real-time credit score and transmits to an issuer the authorization request message comprising an authorization request and the real-time credit score; and,
receiving the authorization decision from the payment processor.

18. The method of claim 17, wherein the authorization request message comprises transaction account information from multiple transaction accounts.

19. The method of claim 17, wherein the authorization request message comprises product information.

20. A computer-readable medium having stored thereon a plurality of instructions for implementing a method for communicating a real-time credit score, the plurality of instructions, when executed by a processor, are configured to cause the processor to perform the method comprising:
receiving an authorization request from a merchant system;
calculating a credit score;
transmitting the credit score to an issuer in an authorization request message;
receiving an authorization reply; and,
transmitting the authorization reply to the merchant system.
